(19) United States
(12) Patent Application Publication
(10) Pub. No.: US 2004/0048656 A1
(43) Pub. Date: Mar. 11, 2004

(54) System and method for pari-mutuel wagering on sporting events

(76) Inventor: Joseph Krynicky, Roselle, NJ (US)

Correspondence Address: Joseph Krynicky, 713 Stanley Terrace, Roselle, NJ, 07203, US

(21) Appl. No.: 10/208,610

(22) Filed: Jul. 30, 2002

(51) Int. Cl. A63F 13/00; A63F 9/24; G06F 17/00; G06F 19/00

(52) U.S. Cl. 463/25

(57) ABSTRACT

A method is disclosed for creating and processing a betting opportunity allowing exotic type pari-mutuel wagering including but not limited to Exactas and Triples to be applied to sporting events including but not limited to football games and basketball games. A bet processing entity selects a metric including but not limited to points scored. This metric is applied to all contestants participating in a plurality of events played during a selected time period. The contestants in the plurality of events obtaining the highest values of the metric are considered the winning contestants for the purpose of the constructed bet and bettors who correctly selected these contestants from all participants competing share in the proceeds of the bets made. Bettors not correctly selecting the highest-ranking participants will not share in the proceeds. This method allows metrics obtained in multiple sporting events to be aggregated into one betting opportunity.

### BACKGROUND

1. Field of the Invention

The invention relates generally to predictive games related to sporting events. More specifically, the invention relates to gambling methods in sporting events.

2. Discussion of Prior Art

Many people watch sporting events for relaxation and the pleasure of rooting for a favorite team or players. As they watch the games, they form opinions on which teams are best and what teams in an athletic contest are more likely to win. Often their enjoyment in watching a sporting event is increased by the ability to place a wager on the sporting event and receive a monetary reward if their selected team wins the sporting event. Companies in several jurisdictions, both domestic and foreign, accept wagers on sporting events.

The simplest form of betting on sporting events is selecting the winners of each contest. This is not efficient for a professional bookmaking entity in that one team may be more likely to win the sporting event than the other team. In this case more bettors will most likely place bets on the perceived superior team, and the bookmaking entity has the potential to lose money if the more highly bet team wins. This problem was addressed in the industry by offering varying odds for the different participants in a sporting event, so that when the team perceived by the majority of the bettors to be superior emerged as the victor in the sporting event, the bettor would receive a lower return than when the team perceived to be less likely to win emerged as the victor.

Another way bet processing entities attempt to balance wagering on both contestants of the sporting event is to add a handicap of a certain number of points to one team for each contest. In this form of wagering, the perceived superior team must win by a pre-selected number of points for the wager to be considered successful on the better team. If the perceived better team won by less than the number of points in the handicap, then it would lose the wager. Likewise, if the team perceived to be worse lost by fewer points than the handicap, bettors selecting that team would win the wager. For this type of wager, the payout returned to the bettor will be the same whether the team perceived to be superior or the team perceived to be inferior has the most points in the contest after adjusting for the added points. This method of accepting wagers is currently the most popular in the legal bookmaking industry.

Many bettors would like the chance to receive a higher payoff for their bets. To offer a higher payoff, the bookmaking entity must increase the level of difficulty in winning the bet. One solution by the bet processing industry was to require bettors to select the winners of multiple games, rather than just one game. If any contestant selected by the bettor lost, the bettor would lose that entire bet. But if all contestants selected by the bettor won their individual contests, the bettor would receive a much higher payoff. In one typical payout schedule—when the winners (after adjusting for points to balance both sides of the bet) of three games were selected correctly, the bettor would win four dollars for each dollar bet. If four games were selected correctly, the bettor would win eight dollars for each dollar bet. If 15 games were selected correctly, 25,000 dollars would be won for each dollar bet. Picking the correct team in this many contests is very difficult for the bettor, but it is a very popular form of wagering, since the small chance of getting a large return for a small bet appeals to many people. There is a disincentive for bookmaking entities to offer larger payouts since in any given week there is a small chance that a bettor may select a large number of games correctly. If this were to happen, the amount the bookmaking entity would be required to pay out for the week might be far more than he collected during that week. Even with the level of difficulty in choosing teams for the bettors and the potential catastrophic payout that might be required by the bookmaking entity, this is a very popular bet.

Because betting on sporting events, especially football games, is so popular, bookmaking entities are constantly trying to develop new betting opportunities. A current example of this is the proposition bet offered by many Las Vegas and foreign bookmaking entities. In this bet, a metric not directly related to the outcome of the game is selected, and bettors are allowed to pick either side of the bet. An example of a proposition bet is “Will a field goal of over 45 yards be successfully kicked in a game.” The popularity of betting propositions like this demonstrate that people enjoy betting on sporting events and are looking for new ways to bet. This invention gives a new way to bet on sporting events that is complementary to existing betting methods. The non-obvious nature of this method is affirmed by the fact that the bets of the type presented in this invention are not currently offered by any bookmaking establishment, even though it is in their best interests to offer as many different types of bets as possible.

Another popular form of gambling is betting on the winner of a horse race. In a sporting event such as a football game where there are two participants, there are only two potential outcomes. One team will win and the other team will lose. A horse race, jai alai game, dog race or other pari-mutuel event will generally have more than two participants. After a winner of the sporting event is selected, it is possible to create a betting opportunity that picks the best of the non-winners. This process can continue picking the best of the contestants remaining in the event after several have completed the race. When there are more participants from whom the winner will be determined, more varied forms of betting can be employed. Pari-mutuel betting is different than the fixed price betting systems used in sporting events betting. When a person makes a bet in a fixed price system, he knows how much money he will be paid if he correctly selects the winner(s). In pari-mutuel betting, the amount that will be paid is determined by totaling all bets made and distributing this total amount bet (after deducting a fixed percentage for expenses and profit) equally among all bettors selecting the winning combination. This system has an operational advantage in that the bookmaking entity cannot lose money on any individual bet. Because the betting public knows that the bookmaking entity will always have the money to pay off any winning wagers from the proceeds of the current race, confidence in ability to collect large winning wagers is increased. This is in contrast to the fixed return bets on parley cards when a bookmaking entity may be required to pay out more than it received in bets that week. Because of this inherent feature of pari-mutuel betting where the bookmaking entity is not at risk of being a net loser on any individual bet, the bookmaking entity is able to offer new bets with increasingly greater potential payouts to the bettors. Originally, bets offered at horse races consisted of Win (Select the horse that will finish first in a race), Place (Select a horse which will finish either First or Second in a race) and Show (Select a horse which will finish either First Second or Third in a race). The demand by bettors for larger payouts, even for the trade off of a lower probability of winning, led to the introduction of Exotic Bets. Exotic Bets require the bettor to pick multiple horses in a race or a series of races. For instance an Exacta bet requires the bettor to pick the horses that will finish first and second in the exact order. A Triple bet requires the bettor to pick the horses that will finish first, second and third in the exact order. A Superfecta bet requires the bettor to pick the horses that finish first, second, third and fourth in the exact order. Other bets are constantly being developed that offer even larger payouts for picking larger combinations of winners such as Super Six, picking the winners of 6 consecutive races and Double Triple which pays the bettor correctly selecting the first, second and third place finishes in 2 consecutive races. For betting opportunities where there is a possibility that no one will select all of the winners, the proceeds of the betting pool are awarded to people picking most of the winners. In some cases, a portion of the betting pool is carried over to the next day or week, increasing the payout for the succeeding contest. Bets of this type are not currently possible for football games because there are only 2 participants in each game. When one team wins, the other team must lose so there is no way to bet other than picking one team to win, which also results in picking the other team to lose. By using a method of aggregating all games played in a period into one betting opportunity, this invention brings the possibility of exotic betting to football games and other sporting events

This invention overcomes limitations, both physical and psychological of current betting methods to create a potentially popular bet that involves some skill, doesn't require extensive knowledge or work on the part of the bettor and has the potential of very large payouts to the bettor for a small bet.

### SUMMARY

This invention establishes a pari-mutuel betting opportunity similar to currently well known in the field exotic betting methods including but not limited to exacta and triple betting where the winning payoff is determined by which teams in a series of sporting events obtain the highest value of a selected metric. This is accomplished by combining several like sporting events into one betting opportunity and evaluating each participant in these sporting events on a common metric.

### Objects and Advantages

Accordingly, several objects and advantages of my invention are:

1Treating all or a subset of games played in a period as one betting proposition creates the mechanism for a bet processing entity to offer the increased variety of bets currently available in the pari-mutuel horse racing industry to sports gambling enthusiasts

The pari-mutuel nature of the payout determination guarantees that the bet taking entity will not be subject to the risk of paying out more money that is received in the betting pool for any single gambling proposition.

This bet is different enough from current bets so that it will not serve only as a replacement for current forms of sports betting, but as an additional type of bet to make, thus increasing the potential betting handle for licensed bookmaking entities.

In sporting events, the most likely teams will score the highest number of points more frequently than the less likely teams, but even the least likely team will occasionally score the most points. This will allow bettors to select strategies when betting. They could attempt to select a bet with a higher percentage chance of winning a smaller amount or a smaller percentage chance of winning a higher amount. This perceived control over betting strategy by the bettors may encourage repeat betting.

In addition to advantages to the bet processing entity, there are advantages to potential bettors who are the customers of the bet processing entity.

Successful bettors can win large payouts for a small bet.

Bettors will have the opportunity to add a level of skill to the process of selecting bets. The entertainment value the bettors receive from their bets can be increased as the results unfold over a series of sporting events taking several hours.

Bettors can increase their enjoyment in watching the game by rooting for points to be scored, in addition to rooting for the outcome of the game. This is possible because a metric different than winning or losing a game is involved in the bet.

Bettors will be able, to a limited degree, to select the risk and return level of the bet by selecting teams more or less likely to score many points to include in their bets.

The bet is simple and can be made by someone with very little knowledge of the sporting events involved. A bettor with substantial knowledge of the sporting events may be able to bet more efficiently using this knowledge. This can make the bet interesting to people with all levels of knowledge of the sporting event. The results of the bet will be easy to determine while watching the sporting events on TV and will be readily available in the next day's newspaper or Internet sporting result sites.

The bet is simple to understand. There is a long history of people familiar with horse racing pari-mutuel bets. Picking teams that will score the most points is consistent with picking the best teams, an easily understood extension on picking the winners of the games.

Further objects and advantages of my invention will become apparent from a consideration of the drawings and ensuing description

### SUMMARY OF THE INVENTION

The disadvantages of the prior art are overcome by the present invention, which is a method that allows exotic pari-mutuel wagering opportunities on the playing of sporting events using the method of combining several individual games into one betting opportunity. This is accomplished by considering a plurality of games played during a period as one betting opportunity, and requiring the bettor to pick the teams that will obtain the highest values of a metric from among these games to successfully win their bet. In the preferred embodiment, the bettor will select which two teams among all Professional Football League teams will score the most points in their games during a given week in the correct descending order of number of points. If the bettor selects the teams in order of points scored, he wins the bet. If he fails to pick the teams that score the most points, he loses the bet.

By allowing the bettor to select teams from all games played in a period, bets can be generated that will be mathematically equivalent to a horse race with 30 or more participants. If each had an equal likelihood to win, the expected payout to the winner would be about 900 dollars for each one dollar bet comprising the picking the top two teams in order and about 27,000 dollars for each one dollar bet comprising the picking the top three teams in order. These payouts would be affected by whether the teams widely perceived to have the best chance to score points did, in fact, score the most points, in which case the payout would be lower, or whether teams which were widely perceived as not likely to score the most points scored the most points in which case the payout could be substantially higher.

### BRIEF DESCRIPTION OF THE DRAWINGS

FIG. 1 is a flow chart representation of the mechanism of the claimed business process

FIG. 2 is a flow chart representation of the usage of this system by bettors, the customers of the bet processing entity.

FIG. 3 is a flow chart of the existing welll known in the art pari-mutuel betting process

### DESCRIPTION OF THE DRAWINGS

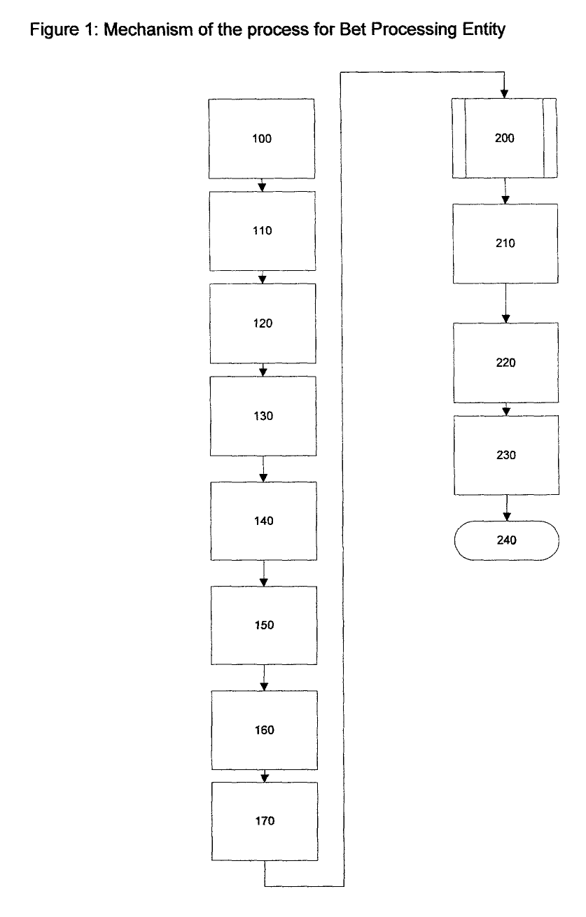

In FIG. 1 Reference numerals 100, 110, 120 and 130 are concerned with the mechanism of developing the bet that will be offered to the public. These steps will be performed one time for each bet created by the bet processing entity before bets are accepted from the public.

FIG. 1 Reference numeral 100 represents the selection of sporting events that will be the universe from which bettors must select their bets. For example, the bet processing entity might choose all National Football League games played between Saturday Morning and Monday Evening on a particular weekend.

FIG. 1 Reference numeral 110 represents the determination of the metric on which the teams selected in reference numeral 100 will be evaluated. For example number of points scored by each team may be chosen as the metric.

FIG. 1 Reference numeral 120 represents the determination of the number of teams that will make up a valid bet. For example, the number 2 could be selected, which will require the bettor to select 2 teams to create a valid bet.

FIG. 1 Reference numeral 130 represents the process of combining the information selected in reference numerals 100, 110, and 120 into a representation that the potential bettor can use to make his bet and submit the bet to the bet processing entity.

FIG. 1 Reference numerals 140, 150 and 160 represent the process of accepting bets from bettors. This process will be repeated many times in the period from the creation of the bet as detailed in reference numerals 100 through 130 through the time when bets are no longer accepted which is represented by reference numeral 170.

FIG. 1 Reference numeral 140 represents the step of accepting the bet from the bettor. Players will make bets and submit these bets to the bet processing entity.

FIG. 1 Reference numeral 150 represents the mathematical actions that must be performed after each bet is received. The amount of the bet is added to both the total amount of all bets received and to the total amount received on this combination selected by the bettor.

FIG. 1 Reference numeral 160 represents the calculation of the payout for a winning bet for each possible combination selected. This step could be performed after each bet is received or at predetermined intervals including but not limited to 10 minute intervals. The current amount that would be paid out for each combination can optionally be displayed for the information of bettors and potential bettors. When the calculation represented in reference numeral 160 is performed after reference numeral 170 occurs, it determines the final payouts for each bet combination.

FIG. 1 Reference numeral 170 represents a time when bets will no longer be accepted. This must occur before any sporting events as selected in reference numeral 100 that can be included in the bet commence.

FIG. 1 Reference numeral 200 represents the occurrence of the sporting events. These events occur outside of the operation of this invention.

FIG. 1 Reference numerals 210, 220 and 230 represent the steps performed by the bet processing entity after the completion of the last of the sporting events selected in reference numeral 100

FIG. 1 Reference numeral 210 represents the process of calculating the winner of the bet. The results of each of the sporting events selected in reference numeral 100 are obtained, and the metric selected in reference numeral 110 is evaluated for each eligible participant in the sporting events. The teams obtaining the highest metrics are identified.

FIG. 1 Reference numeral 220 represents the paying of bets to the winning bettors. Bettors who selected the teams obtaining the highest metrics are paid the final amount determined in the process referred to in reference numeral 160 No action need be taken for non-winning bettors.

FIG. 1 Reference numeral 230 represents the action taken by the bet processing entity to the non-winning bettors. Bettors who did not select the teams obtaining the highest metrics receive nothing from the bet processing entity.

FIG. 1 Reference numeral 240 represents the end of the process as performed by the bet processing entity

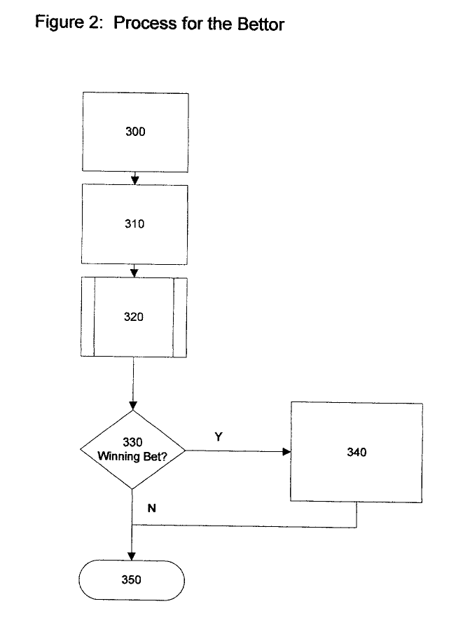

FIG. 2 is a flow chart representing the steps performed by the bettor, who is the customer of the bet processing entity

FIG. 2 Reference numeral 300 represents the bettor selecting teams on which to bet. The bettor will make his selection from the list of valid bets supplied by the bet processing entity in FIG. 1 reference numeral 130.

FIG. 2 Reference numeral 310 represents the action of the bettor submitting the bet to a bet processing entity.

FIG. 2 Reference numeral 320 represents the occurrence of the sporting events which were bet on and which occurs outside of the scope of the betting process

FIG. 2 Reference numeral 330 represents the determination of whether the bettor has won or lost his bet. This step will be performed by the bet processing entity, but can be verified by the bettor from sporting event results printed in a newspaper or displayed on the Internet.

FIG. 2 Reference numeral 340 represents the bettor receiving the proceeds of the bet from the bet processing entity if he has selected the winning proposition in the bet. The bettor will receive no money from the proceeds of the bet if he has not selected the winning side in the bet

FIG. 2 Reference numeral 350 represents to completion of the process as seen by the bettor

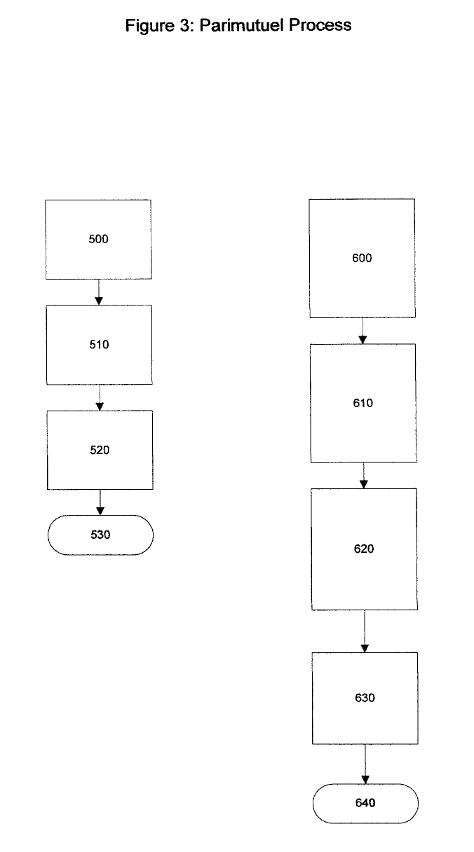

FIG. 3 is a flow chart representing the well known in the art pari-mutuel process for accepting and calculating the proceeds of bets.

FIG. 3 Reference numerals 500, 510, 520 and 530 represent the bet acceptance phase of the well known in the art pari-mutuel process.

FIG. 3 Reference numeral 500 represents the determination of all possible outcomes for a bet. In a horse race, this would include all horses running in the race. In the present invention it includes all propositions created in FIG. 1 Reference numbers 100, 110 and 120.

FIG. 3 Reference numeral 510 represents the step of accepting the bet from the bettors. The bet will be on one of the outcomes determined by FIG. 3 reference number 500.

FIG. 3 Reference numeral 520 represents the record keeping performed by the bet accepting entity for each bet received. The amount bet is added to both the total for the particular combination selected by the bettor and to the grand total.

FIG. 3 Reference numerals 510 and 520 are performed for each bet received by the bet accepting entity.

FIG. 3 Reference numeral 530 represents the completion of the bet acceptance phase in pari-mutuel processing.

FIG. 3 Reference numerals 600, 610 and 620 represent the process of calculating the amount that will be paid to winning bettors. This calculation must be performed for the winning outcome. It may optionally be performed for non-winning outcomes if feedback to bettors and potential bettors is desired.

FIG. 3 Reference numeral 600 represents the first step of determining the payout. In this step the total amount bet is divided by the amount bet on each possible outcome.

FIG. 3 Reference numeral 610 represents the second step in determining the payout. The projected payout calculated in the step represented in reference numeral 600 is decreased by a predetermined percentage to allow for expenses and profit for the bet processing entity. This amount represents the amount that will be paid to each winning bettor for each dollar bet.

FIG. 3 Reference numeral 620 represents the final step in determining the payout for a winning bettor. The final payout is calculated by multiplying the amount determined in the step represented by reference numeral 610 by the amount bet by the bettor.

FIG. 3 Reference numeral 630 represents the step of paying winning bettors the amount calculated in the step represented by reference number 620

FIG. 3 Reference numeral 640 represents the end of the payout calculation phase in pari-mutuel processing.

### DESCRIPTION OF INVENTION

The business method being invented is the creation and processing of a betting opportunity derived from aggregating several like sporting events into a single betting opportunity and requiring the bettor to pick a plurality of teams obtaining the highest amount of a selected metric from teams participating in these aggregated sporting events. This said metric is independent of whether the team wins or loses the underlying sporting event. Well known in the art methods of pari-mutuel bet processing and well-known exotic betting methods from the horse racing industry are included in the process.

In the preferred embodiment, the teams eligible to be bet upon would be all National Football League teams participating in games played in a given week. The metric selected would be total points scored by each said team. Whether the said team won their game or lost their game would be irrelevant. It would be possible for a losing team to score the 2^{nd} or 3^{rd} highest point total for a week. It would not be possible for a losing team to score the highest point total for a week. From this plurality of said teams, the bettor make a bet by picking the said team that would score the highest amount of said total points as well as the said team that would score the second highest amount of said total points. If said bettor correctly selected the said teams scoring the said highest amount of points and the said team scoring the second highest amount of points, the said bet would be considered a winner and would be awarded a portion of the total bet pool determined by well known pari-mutuel calculation methods. If said bettor did not select the said teams scoring the said highest points and the said team scoring the second highest total of points, the bet would be considered a loser and would not be awarded a portion of the said total bet pool.

### Operation of Invention

The present invention provides a method for a wagering system that accepts bets on sporting events. The method of the present invention combines several sporting events into one aggregate bet. The bet is composed of selecting a predetermined number of teams from a predetermined plurality of teams that will obtain the highest values for a predetermined metric. The well known in the art methods of pari-mutuel betting will be used to determine the payout amount won on winning bets.

The operation of the method consists of the following steps.

a. A list of teams to be included in the wagering possibilities is selected as well as the time period in which the games involving these teams will be played. In the preferred embodiment this would be all National Football League games played during a given weekend.

b. The metric that will be used to determine the winning selections is determined. In the preferred embodiment this is the total number of points scored by each team in the game.

c. A visualization of allowable bets is made available to potential customers. These visualizations include, but are not limited to, printed media with a list of allowable bets and an Internet interface showing allowable bets.

d. The bet processing entity allows customers make bets from the list of allowable combinations and submit their selected combinations along with the amount of the bet.

e. The bet processing entity receives the bets and the said bets are combined into a pool with all other bets received. Appropriate record keeping is performed so that customers who made each bet can be identified for the purposes of paying bettors who selected the correct teams.

f. As the bet processing entity places each bet into the pool, the revised payout for each bet combination is calculated. A predetermined percentage will be subtracted from the pool to cover expenses and profit for the bet processing entity. This will represent the Net Total Pool. The expected payout for the selected combination is then calculated as Net Total Pool divided by the amount bet on the selected combination. This calculation represents the amount that will be paid to a bettor selecting that combination that obtains the highest metrics among all teams available to be selected.

g. The bet taking entity may make available the currently calculated payout for every combination for examination by potential customers. The mechanism to make this information available may include an Internet web interface among other potential display methods. It is not necessary, but highly desirable for current updated payouts to be made available to customers and potential customers

h. At a predetermined time before the start of the first of the said selected sporting events, acceptance by the bet taking entity of said bets will cease. Final calculations as detailed in step f. will be made for each combination. These calculations determine the actual amount that will be paid to bettors selecting the winning combination.

i. External to the method, the said sporting events will be played

j. After the completion of the last of said sporting events, the bet taking entity will determine the teams that obtained the highest value of the said selected metric.

k. The bet taking entity will pay the amount determined in the said potential payout as described in step f for that combination from the said aggregated wagering pool to all customers who selected in the correct order the teams that obtained the highest metrics.

l. The bet taking entity will make no payout to customers who did not select in correct order the teams that obtained the highest metrics.

### Description and Operation of Alternative Embodiments

a. The selection of sporting events used to construct the bet may include National Football League games played during a specified period, National Basketball Association games played during a specific period, National Collegiate Athletic Association Tournament Games or Major League Baseball games played during a specific period.

b. The selection of sporting events used to construct the bet may be a subset of all games played in a period. For instance only games including Eastern Conference Teams of the National Football League or only games including teams ranked in the top 3 in the league may be included in the plurality of teams used to construct the bet.

c. The bet processing entity can construct wagers having the requirement to pick different amounts of selections. Specifically the bet processing entity may determine that the bettor must select 2 teams when constructing the wager. The bet processing entity could also determine that 3 teams be used when constructing the wager. Likewise, 4, 5, or 6 teams might be used in constructing the wager

### Conclusion, Ramification and Scope of Invention

Thus the reader will see that this invention provides a bet processing entity the ability to construct an attractive betting opportunity, which combines the exotic betting methods popular at horse racing events with the popularity of betting on sporting events such as football. The mathematically expected large payoffs also will appeal to lottery players, giving customers an increased entertainment value for the bet.

The non-obvious nature of this invention is demonstrated by the unavailability of similar bets currently being offered by licensed bookmaking entities. Bookmaking is a very competitive industry and new ways to bet on sporting events are constantly being offered. A method that used pari-mutuel methods to guarantee a profit to the bookmaking entity would be especially likely to be offered if it existed in the prior art. The vast majority of prior art has concentrated on methods that included the winning or losing of each game as the sole or main basis of any new betting method invented. The betting method described in this invention where each team is evaluated on a common metric against all other teams instead of against only the team it is playing allows the methods and advantages of exotic bets such as exactas and triples and pari-mutuel methods to be included in sports betting propositions.

While my above description contains many specificities, those should not be construed as limitations on the scope of the invention, but rather an exemplification of one preferred embodiment thereof. Many other variations are possible.

Accordingly the scope of the invention should be determined not by the embodiments illustrated, but by the appended claims and their legal equivalents.

The following is claimed:

1. A method for an entity to create and process a betting opportunity allowing a customer to wager on a plurality of sporting events using elements of well-known pari-mutuel processing, said method comprising the steps of
a) Selecting the said sporting events on which to accept wagers from a plurality of all sporting events
b) Selecting a metric on which to evaluate participants in said selected sporting events
c) Selecting the number of selections that will constitute a valid bet that customers must choose when submitting wagers
d) Optionally generating an input method including but not limited to Internet pages and printed forms on which said customers can enter said wagers
e) Allowing said customers to select the number of said participants as determined in step c from said sporting events selected in step a and submit said wagers to the entity employing the business method.
f) Adding amount of each said wager received to a payout pool of money consisting of all money received from said wagers
g) Calculating the projected payout for each combination on which said wagers were received using well known in the field formulas for calculating pari-mutuel payouts
h) External to this method, said sporting events will transpire
i) After the completion of all said sporting events, determining said metrics for said selected participants
j) Paying said customers who selected the said participants obtaining the highest said metrics with said projected payout from the said payout pool

2. The method of claim 1 wherein the number of selections required for creation of a valid wager is 2

3. The method of claim 1 wherein the number of selections required for creation of a valid wager is 3

4. The method of claim 1 wherein the number of selections required for creation of a valid wager is 4

5. The method of claim 1 wherein the number of selections required for creation of a valid wager is 5 or greater

6. The method of claim 1 wherein the selected sporting events comprise games played by the National Football League teams

7. The method of claim 1 wherein the selected sporting events comprise games played by Major League Baseball teams

8. The method of claim 1 wherein the selected sporting events comprise games played by National Basketball Association teams

9. The method of claim 1 wherein selected sporting events comprise games played by National Collegiate Athletic Association members

10. The method of claim 1 wherein customers must select the teams obtaining the highest metrics in the exact ordering of value of metrics obtained

11. The method of claim 1 wherein customers must select teams obtaining highest metrics without regard to exact ordering of value of metrics obtained.

12. The method of claim 1 wherein communication between entity and customer is conducted using the Internet

13. The method of claim 1 wherein updated projected payouts for all combinations are made available for display to customers and potential customers

14. The method of claim 1 wherein randomly generated selections are generated by the entity for the customer instead of requiring said customer to make selections

15. The method of claim 1 wherein multiple wagers may be submitted in one transaction

16. The method of claim 1 wherein the metric selected is number of points scored by each team

17. The method of claim 1 wherein selected sporting events comprise games played by teams in a plurality of sports or leagues. For instance some teams in the National Hockey League and Major League Baseball may be combined to create the universe of teams available for the bet.

18. The method of claim 1 wherein the metric selected is the combine points scored by both teams in a sporting event

19. The method of claim 1 wherein the metric selected is the total achieved of some metric by both teams participating in a sporting event. For example, in a football game, the metric might be total passing yards obtained by both teams

20. A method of gambling, comprising the steps of:
An entity selecting a plurality of sporting events;
An entity selecting a metric related to the plurality of sporting events;
A bettor choosing a plurality of contestants from the plurality of sporting events;
A bettor placing a bet on the plurality of contestants chosen;
A waiting the results of the plurality of sporting events;
Ordering the plurality of contestants according to performance of the selected metric; and
An entity calculating a payout for the bets placed on the plurality of contestants that have the highest order of performance related to the selected metric.
